(19) United States
(12) Patent Application Publication
(10) Pub. No.: US 2026/0313086 A1
(43) Pub. Date: Oct. 8, 2026

(54) MODULAR ADAPTIVE ILLUMINATION SYSTEM FOR DUAL-PURPOSE INTERACTIVE APPARATUS

(71) Applicant: NANNETTE SUAREZ, Hialeah, FL (US)

(72) Inventor: NANNETTE SUAREZ, Hialeah, FL (US)

(21) Appl. No.: 19/171,223

(22) Filed: Apr. 5, 2025

(51) Int. Cl. H04N 13/393; A45C 15/06; H04N 13/324; H04N 13/398

(52) U.S. Cl. CPC H04N 13/393; A45C 15/06; H04N 13/324; H04N 13/398; H04N 2213/001

(57) ABSTRACT

A system and method for an interactive apparatus with customizable features that may be quickly accessed by a user whereby the users' settings are automatically uploaded providing a more personalized experience. The apparatus may include modular components that may hold interactive experiences as well as light up or display images.

### FIELD OF DISCLOSURE

This invention operates within the realm of wearable and stationary technology, encompassing apparatus designed for both personal use as well as ambient lighting in static settings.

### BACKGROUND

Traditional headwear lacks dynamic and interactive features that cater to user preferences and expression. They also do not provide synchronized lighting for collective visual impact. Current designs lack depth or dimensionality and do not provide modularity for customization. Additionally, it fails to provide uniform lighting to properly illuminate designs. This illuminated apparatus addresses these shortcomings by introducing wireless adjustable illumination control and synchronized lighting capabilities, backlighting elements, interchangeable layered designs, and modular housing, making it versatile for both personal use and ornamental display.

### SUMMARY

The modular illuminated system transforms the concept of headwear into an interactive canvas for self-expression and dynamic visual displays whether on the move or in a stationary setting. Users can synchronize lighting capabilities, customize the display and control the intensity and color of the lights wirelessly through a user-friendly interface adding a new layer of personalization. Configurations are customizable with modular housing and interchangeable designs. Uniform backlighting provides proper distribution of light to illuminate scenes. The overlay of interchangeable layered designs and homogenous lighting creates depth and three dimensionality enhancing visual impact. These set of features collectively redefine the capabilities of light-up headwear catering to personal expression and environmental ambiance in both wearable and static configurations. This is not limited to the use of discrete illumination to illuminate scenes, but also may include the use of display technologies such as backlit LCDs, LEDs, OLEDs, to perform the same function both statically and dynamically.

### BRIEF DESCRIPTION OF DRAWINGS

The present invention will be described by way of exemplary embodiments, but not limitations, illustrated in the accompanying drawings in which like references denote similar elements, and in which:

FIG. 1 shows an illustration of the modular component of the interactive apparatus system.

FIG. 2 shows a cut through view of the modular component.

FIG. 3 shows a front view of the modular component.

FIG. 4 shows a first embodiment of the interactive apparatus system.

FIG. 5 shows a second embodiment of the interactive apparatus system.

FIG. 6 shows a block diagram of the interactive apparatus system.

FIG. 7 shows a block diagram of the computing devices of the interactive apparatus system

FIG. 8 shows a third embodiment of the interactive apparatus system.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or another embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. Appearances of the phrase “in one embodiment” in various places in the specification do not necessarily refer to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skills in the art to which this disclosure pertains.

The disclosed technology addresses the need for a new apparatus that provides a more customizable experience. The apparatus may include a modular base or housing material with embedded 3D design elements stored within the housing. These design elements may include but are not limited to patterns, motifs, or textures that enhance the overall aesthetic appeal. Additionally, a backlighting system is strategically integrated to provide an even distribution of light. Backlighting may also include screen displays for selective animated elements. The backlighting is controlled by a wireless user-friendly interface on a remote computing device, modifying intensity, color, and visual content. The interface also allows for multiple units to be controlled simultaneously for collaboration between multiple users.

The modular illuminated apparatus may also include several key features such as a wireless adjustable illumination control whereby users may dynamically control the intensity and color of the lights wirelessly through a user-friendly interface, promoting personalization and adaptability. The apparatus incorporates a modular system enabling users to effortlessly swap out different layered designs, facilitating diverse aesthetic expressions. Multiple apparatus units can synchronize their lighting, allowing for visually cohesive and impactful displays during group events or performances. An integrated rechargeable battery may be housed to ensure portability and extended use, freeing users from the constraints of wired connections. The system may include LED backlighting, adding an extra layer of visual appeal and versatility to the apparatus creating uniform lighting and offering users more control and flexibility for customization. The system may include an LCD display seamlessly integrated into the apparatus that provides an interactive platform for dynamic visual content, information display, or personalization.

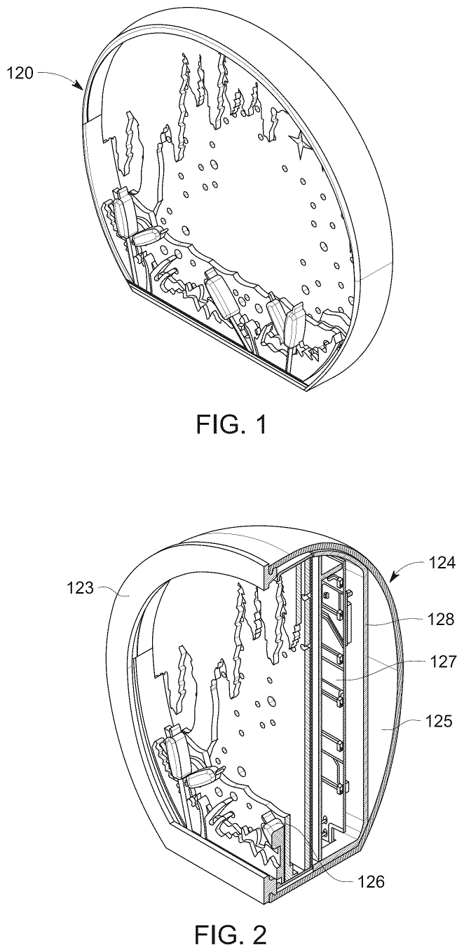

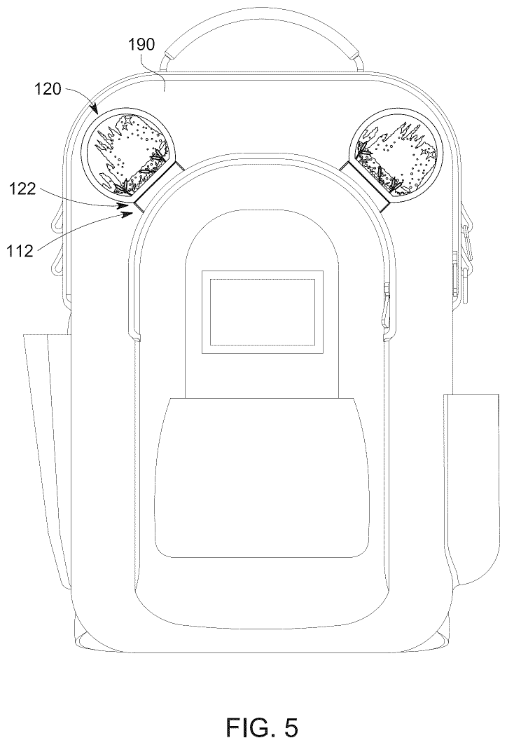

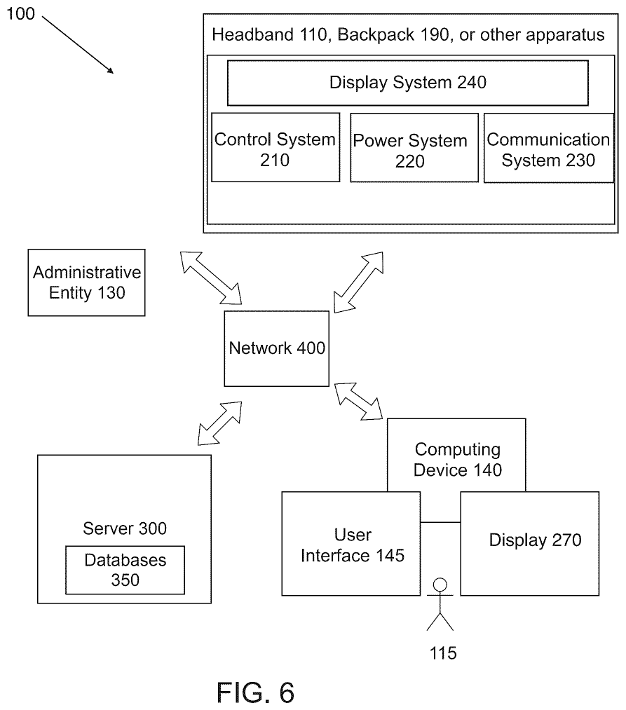

FIG. 4 depicts a front view of one embodiment of interactive apparatus system 100, in accordance with the present invention. Interactive apparatus system 100 may in one embodiment include headpiece and include components such as a headband 110 and modular components 120 as illustrated in FIG. 1, and an application 130 on a remote computing device 140, as illustrated in FIG. 6. Headband 110 may be made of a flexible material with a continuous band portion configured to encircle and conform to a user's head, whereby the band portion may be constructed from elastic materials including but not limited to nylon, spandex, polyester, cotton, or combinations thereof. The flexible nature of the band portion enables adjustable positioning of the magnetic attachment plates while maintaining secure contact with the user's head. In further non-limiting embodiments, headband 110 may be another object such as a backpack 190, purse, pendant, or chair or any other type of apparatus that may receive and connected to modular components 120, as illustrated in FIG. 5. For instance, in these examples, backpack 190 may have metal plates sewn to or otherwise connected to corresponding metal plates interior or exterior of backpack 190.

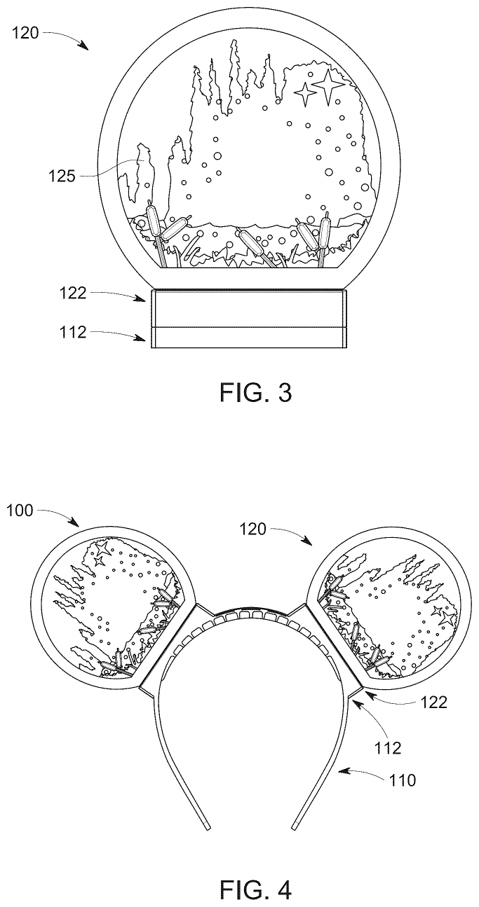

Headband 110 may have first and second magnetic attachment plates 112 fixedly secured to opposing upper quadrant sides of said band portion on an inner surface or outer surface (10 and 2 on a clock), as illustrated in FIG. 3, whereby each magnetic attachment plate 112 includes a substantially flat surface oriented tangential to the circumferential direction of the band portion in upward diagonal directions. The magnetic attachment plates 112 are configured to removably couple with compatible magnetic plates 122 of modular components 120 which may be positioned on a bottom of modular components 120 such that modular components 120 may be positioned on opposing upper quadrants of headband 110, similar to a rodent's ears. The engagement between the magnetic plates creates a removable connection that maintains the structural integrity while allowing for intentional disassembly when desired for new modular components 120 for customization.

Modular components 120 may include a housing assembly with magnetic plates 122 for attachment to various apparatuses as illustrated in FIG. 2. Housing assembly may include a front face plate 123 and a complementary back plate 124 configured to mate with one another while in further embodiments the housing assembly may just have a back face plate 124 with a recessed cavity. The back plate 124 includes a plurality of receptacle features arranged in a predetermined pattern across its surface. These receptacle features are positioned to engage with corresponding mating features on the front face plate 123, enabling secure assembly and disassembly of the housing components.

When the front face plate 123 and back plate 124 are joined together through engagement of their respective mating features, they form an enclosed volume defining a hollow interior compartment 125 suitable for storage of various dioramas or settings or other environments. The environments may be in the form embedded 3D design elements 126 stored within hollow interior compartment 125 and may be fastened or removably fastened by any means known by those of ordinary skill in the art such as but not limited to adhesive, latches, hinges, magnets, or other fasteners. These design elements may include but are not limited to patterns, motifs, or textures that enhance the overall aesthetic appeal such as a castle, a savannah, a jungle, a cathedral, or any other location with a variety of characters and supporting scenery.

The engagement between the receptacle features of the back plate 124 and the mating features of the front face plate 123 plate creates a stable connection that maintains the structural integrity of the housing assembly while allowing for intentional disassembly when desired. The housing assembly may be manufactured from various suitable materials, and the specific configuration of the receptacle and mating features can be adapted to meet different application requirements while maintaining the fundamental connecting relationship between the front face plate and back plate components.

Interactive apparatus system 100 may have a plurality of systems including a control system 210, a power system 220, and a communication system 230, and a display system 240 which may be integrated in combination within the structure of interactive apparatus system 100. The various systems may be individually configured and correlated with respect to each other so as to attain the desired objective of providing an Interactive apparatus system 100, as illustrated in FIG. 6.

Power system 220 of Interactive apparatus system 100 may provide the energy to Interactive apparatus system 100 including the circuits and components of control system 210 and display system 240 during operation of Interactive apparatus system 100. Interactive apparatus system 100 may be powered by methods known by those of ordinary skill in the art. In some embodiments, power system 220 may include a rechargeable battery pack whereby the rechargeable battery is of a charge, design, and capacity, to provide sufficient power to Interactive apparatus system 100 and the circuits and components of control system 210 while Interactive apparatus system 100 is running for a set period of time.

Power system 220 may include a charging system with a charging base (transmitter) and the device's charging coil (receiver) that provides a magnetic charging system. In the charging base, alternating current flows through a wire coil, creating an oscillating magnetic field. This field extends a short distance from the charging surface. When the user places modular components 120 on the charger, the magnetic field passes through the receiving coil in your device. As this changing magnetic field moves through the receiving coil, it induces an electric current through a process called electromagnetic induction. The induced current is then converted from AC to DC by a rectifier circuit in modular components 120. Power management circuits regulate the voltage and current to charge modular components 120.

Control system 210 may operate to control the actuation of the other systems. Control system 210 may have a series of computing devices which will be discussed in detail later in the description. Control system 210 may be in the form of a circuit board, a memory or other non-transient storage medium in which computer-readable coded instructions are stored, and one or more processors configured to execute the instructions stored in the memory. Control system 210 may have a wireless transmitter, a wireless receiver, and a related computer process executing on the processors.

Computing devices of control system 210 may be any type of user computing device that typically operates under the control of one or more operating systems which control scheduling of tasks and access to system resources. The computing devices may be a phone, tablet, television, desktop computer, laptop computer, gaming system, wearable device electronic glasses, networked router, networked switch, networked, bridge, or any user computing device capable of executing instructions with sufficient processor power and memory capacity to perform operations of control system 210.

The one or more computing devices may be integrated directly into control system 210, while in other non-limiting embodiments, control system 210 may be a remotely located user computing device or server configured to communicate with one or more other control systems 210 in interactive apparatus system 100. Control system 210 may also include an internet connection, network connection, and/or other wired or wireless means of communication (e.g., LAN, etc.) to interact with other components. These connections allow the users to update, control, send/retrieve information, monitor, or otherwise interact passively or actively with control system 210.

Control system 210 may include control circuitry and one or more microprocessors or controllers acting as a servo control mechanism capable of receiving input from various components of interactive apparatus system 100 as well communication system 230, analyzing the input from the components and communication system 230, and generating an output signal to the various components and communication system 230. The microprocessors (not shown) may have on-board memory to control the power that is applied to the various components, power system 220, and communication system 230, in response to input signals from the users and the various components of interactive apparatus system 100.

Control system 210 may maintain one or more databases including a library of digitized auditory signals including songs for play on the microphone through a speaker, whereby the library may be changed or updated through communication by server 300. Control system 210 may also receive and store data constituting images (e.g., still and/or moving video and/or graphical images) that may be displayed on interactive apparatus system 100.

Interactive apparatus system 100 may include local wireless circuitry, which would enable short-range communication to another user computing device as well as Bluetooth sensors and NFC chips. The local wireless circuitry may communicate on any wireless protocol, such as infrared, Bluetooth, IEEE 802.11, or other local wireless communication protocol.

Interactive apparatus system 100 may have one or more communication ports coupled to the circuitry to enable a wired communication link to another device, such as but not limited to another wireless communications device including a laptop or desktop computer, television, video console, speaker, smart speaker, or voice assistant such as Alexa Echo®. The communication link may enable communication between Interactive apparatus system 100 and other devices by way of any wired communication protocol, such as USB wired protocol, RS-232, or some proprietary protocol. Interactive apparatus system 100 may have a global positioning system (GPS) unit coupled to the circuitry to provide location information to the circuitry whereby the GPS may provide the location information related to the location of interactive apparatus system 100 as known by those of ordinary skill in the art.

Interactive apparatus system 100 may communicate with other devices via communication links, such as USB (Universal Serial Bus) or HDMI/VGA (High-Definition Multimedia Interface/Video Graphics Array). Interactive apparatus system 100 may include voice recognition capable software that may be used to navigate or issue instructions as well as fingerprint recognition software, optical scanners, optical pointers, digital image capture devices, and associated interpretation software. Interactive apparatus system 100 may utilize additional Input Devices 265 and Other I/O 275 in the form of examples such as a speaker, smart speaker, microphone, headphone jack, indicator lights, and vibrational motor.

Modular components 120 may have a display screen 128 which may be integrated into front face plate 123, back plate 124, or a connected component and displayed in any way that would be appreciated by one of ordinary skill in the art. In this example embodiment, display screen 128 is a touchscreen display screen connected to control system 210 and operative to display visual contents in the form of both still images and/or video. The display screen 128 is further operative to receive user inputs via touch instructions. The contents displayed by the display screen 128 may be predetermined content (e.g., music video, picture, etc.) and/or content generated in real-time via touch instructions. One or more display screens 128 may also be featured on the inside or outside of modular components 120 for visualization by the user or surrounding people.

Modular components 120 may include a color-adjustable lighting system with an LED light assembly 127 capable of wireless communication with a computing device 140 such that 3D design elements 12 may be lit up through hollow interior compartment 125. The LED light assembly 127 includes a plurality of light-emitting diodes configured to emit light at different wavelengths, whereby the combination of said wavelengths produces user-selectable colors. A wireless communication module within the LED light assembly 127 enables bidirectional data transfer with application 130. Application 130 may provide a user interface 145 for selecting desired colors, brightness levels, and lighting patterns, whereby user inputs received through said interface are transmitted to the LED light assembly 127. The LED light assembly 127 includes a microcontroller that receives color selection commands from application 130 and adjusts the relative intensities of the individual light-emitting diodes to produce the selected color output. Interactive apparatus system 100 may further include memory for storing preset color combinations and lighting patterns that can be accessed and modified through the application interface. The microcontroller may also include firmware capable of receiving updates through the wireless communication module to enable additional functionality and improved performance over time. In further embodiments, there may be no LED light assembly 127 and instead the rear component has an opening so as to let sunlight shine through and illuminate the display.

Control system 210 may be in communication with communication system 230, as illustrated in FIG. 3 to connect with other computing devices whereby signals transmitted from the computing devices may be received by control system 210. Communication system 230 may allow users 115 to interact with control system 210 using a user computing device such as computing devices 140 such as a phone to send or stream light changes and text, image, or audio to the display screen on modular components 120. Users 115 may access a user interface, such as user interface 145 using computing devices 140. User interface 145 may have a plurality of buttons or icons that are selectable by user 115 for communication system 230 to perform particular processes in response to the selections. User interface 145 may have conventional GUI interface devices such as a title bar, toolbars, pull-down menus, tabs, scroll bars, context help, dialog boxes, operating buttons (icons) and status bar that enable user navigation throughout the display.

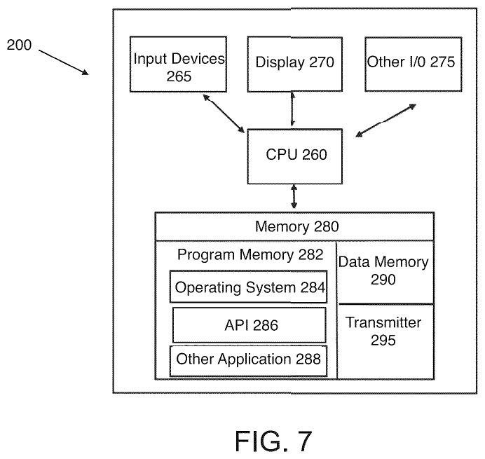

As previously described, interactive apparatus system 100 may be connected to a computing device 140. Turning to FIG. 7, FIG. 7 is a block diagram showing various components of computing device 140. Computing device 140 may comprise a housing for containing one or more hardware components that allow access to edit and query wireless communication interface 205. Computing device 140 may include one or more input devices such as input devices 265 that provide input to a CPU (processor) such as CPU 260 of actions related to user 200. Input devices 265 may be implemented as a keyboard, a touchscreen, a mouse, via voice activation, wearable input device, a 3D camera, a trackball, a microphone, a fingerprint reader, an infrared port, a controller, a remote control, a fax machine, and combinations thereof. The term CPU is non-limiting and instead may be a MCU, MPU, SOCs, ASIC's, or any other components known by those of ordinary skill in the art.

The actions may be initiated by a hardware controller that interprets the signals received from input device 265 and communicates the information to CPU 260 using a communication protocol. CPU 260 may be a single processing unit or multiple processing units in a device or distributed across multiple devices. CPU 260 may be coupled to other hardware devices, such as one or more memory devices with the use of a bus, such as a PCI bus or SCSI bus. CPU 260 may communicate with a hardware controller for devices, such as for a display 270. Display 270 may be used to display text and graphics. In some examples, display 270 provides graphical and textual visual feedback to a user.

In one or more embodiments, display 270 may include an input device 265 as part of display 270, such as when input device 265 is a touchscreen or is equipped with an eye direction monitoring system. In some implementations, display 270 is separate from input device 265. Examples of display 270 include but are not limited to: an LCD display screen or an LED.

Display 270 may be binocular head mounted display (HMD), head mounted goggles (HMG), an augmented reality device, virtual reality glasses, a scope simulator, a hologram a monocular simulator, a binoculars simulator, or a telescope simulator, Google Glass™, or another form of device that is connectable to the computing device whereby user may view a virtual environment through the display.

In one or more non-limiting embodiments, display 270 may be a mobile device or other device. The camera of a mobile device may capture video of the surrounding area so that user 200 may interact with the augmented reality view by inserting annotations, comments, virtual objects, pictures, audio, and video, to locations within range of computing device 140. The virtual objects may include virtual characters or static virtual objects, and any other virtual objects that can be rendered by the augmented reality networking system built within the system. These interactions may be viewed by other users who may also build upon the interactions or make additional interactions that then may be seen by the original user or a third user.

Other I/O devices such as I/O devices 275 may also be coupled to the processor, such as a network card, video card, audio card, USB, FireWire or other external device, camera, printer, speakers, CD-ROM drive, DVD drive, disk drive, or Blu-Ray device. In further non-limiting embodiments, a display 270 may be used as an output device, such as, but not limited to, a computer monitor, a speaker, a television, a smart phone, a fax machine, a printer, or combinations thereof.

CPU 260 may have access to a memory such as memory 280. Memory 280 may include one or more of various hardware devices for volatile and non-volatile storage and may include both read-only and writable memory. For example, memory 280 may comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. Memory 280 may be a non-transitory memory.

Memory 280 may include program memory such as program memory 282 capable of storing programs and software, including an operating system, such as operating system 284. Memory 280 may further include an application and application programming interface (API), such as application 130, and other computerized programs or application programs such as application programs 288. Memory 280 may also include data memory such as data memory 290 that may include database query results, configuration data, settings, user options, user preferences, or other types of data, which may be provided to program memory 282 or any element of computing device 140.

Computing device 140 may have a transmitter 295, such as transmitter 295. Transmitter 295 may have a wired or wireless connection and may comprise a multi-band cellular transmitter to connect to the server over 2G/3G/4G/5G cellular networks. Other embodiments may also utilize Near Field Communication (NFC), Bluetooth, or another method to communicate information.

In some embodiments, interactive apparatus system 100 and computing device 140 may be in communication with one or more servers, such as server 300 or one or more networks such as network 400. Server 300 may be located at a data center, or any other location suitable for providing service to network 400 whereby server 300 may be in one central location or in many different locations in multiple arrangements. Server 300 may comprise a database server 350 such as MySQL® or Maria DB® server. Server 300 may have an attached data storage system storing software applications and data. Server 300 may have a number of modules that provide various functions related to interactive apparatus system 100. Modules may be in the form of software or computer programs that interact with the operating system of server 300 whereby data collected in databases as instruction-based expressions of components and/or processes may be processed by one or more processors within server 300 or as well as in conjunction with execution of one or more other computer programs. Modules may be configured to receive commands or requests from interactive apparatus system 100, computing device 140, server 300, and outside connected devices over network 400. Server 300 may comprise components, subsystems, and modules to support one or more management services for interactive apparatus system 100.

In one or more non-limiting embodiments, network 400 may include a local area network (LAN), such as a company Intranet, a metropolitan area network (MAN), or a wide area network (WAN), such as the Internet or World Wide Web. Network 400 may be a private network or a public network, or a combination thereof. Network 400 may be any type of network known in the art, including telecommunications network, a wireless network (including Wi-Fi), and a wireline network. Network 400 may include mobile telephone networks utilizing any protocol or protocols used to communicate among mobile digital computing devices (e.g. computing device 140), such as GSM, GPRS, UMTS, AMPS, TDMA, or CDMA. In one or more non-limiting embodiments, different types of data may be transmitted via network 400 via different protocols. In alternative embodiments, computing devices 140, may act as standalone devices or whereby they may operate as peer machines in a peer-to-peer (or distributed) network environment.

Network 400 may further include a system of terminals, gateways, and routers. Network 400 may employ one or more cellular access technologies including 2nd (2G), 3rd (3G), 4th (4G), 5th (5G), LTE, Global System for Mobile communication (GSM), General Packet Radio Services (GPRS), Enhanced Data GSM Environment (EDGE), and other access technologies that may provide for broader coverage between computing devices if for instance they are in a remote location not accessible by other networks.

Computing device 140 or server 300 may have one or more modules operable to perform and implement various types of function, actions, and operations for having a processor which may execute an application or program and generate its own modified video signal based on the information received from interactive apparatus system 100. The application may be downloaded from the Internet using a wired or wireless connection. The application may be part of an online marketplace for applications for personal viewing devices. In some embodiments, the application may be hard-coded into the processor.

User 200 may initially register to become a registered user of application 130. When user 200 initially registers to become a registered user of application 130, user 200 may be prompted to provide some personal information along with a requested account name and password, such as, without limitation, their name, age (e.g., birth date), gender, interests, contact information, home town, address, their visual capabilities such as only being able to see out of the left or right eye as well as other preferences. User preferences may also aid user 200 choosing defaults for common settings such as vocal levels, effects, settings when sharing, audio, and video recordings.

In some embodiments, when registering a user account, application 130 may allow user 200 to access and interact with application 130 using login credentials from other social networking platforms. For example, in some embodiments, it may be useful and convenient for users of application 130 to be able to log in using credentials or sign in information from another social media application, such as Facebook®, Apple®, Snap®, or the like. This is advantageous for users who do not wish to have to learn or provide multiple types of login information.

Application 130 may provide a color selection module through user interface 145 for adjusting the lighting on modular components 120. User interface 145 may include a graphical color wheel interface element, direct input of numerical color values, and selection from predefined color presets. User interface 145 may present a brightness control system that may implement a slider interface element for continuous adjustment of illumination intensity, numerical input of brightness percentage values, and incremental adjustment buttons. User interface 145 may present a management system that may enable storage of user-defined color and brightness combinations, recall of previously stored settings, and provide modification of existing presets. User interface 145 may present a visual preview system that generates a real-time visualization of selected parameters and a simulated representation of the resulting illumination effect that will be transmitted to modular components 120.

Application 130 may provide a display control module handles all aspects of textual presentation, including support for scrolling, static, and animated text with variable font characteristics whereby text, images, or videos, may be uploaded or otherwise sent from computing device to the modular components

After registering, user 200 may invite other users, or be invited by other users, to connect via application 130. The connection may be mutual where both users consent to the connection. In some embodiments, the connection may be one sided where one user “follows” the other user, which does not require the other user's consent. When one user has a connection with another user, the connected users may be able to communicate with the other user as well as receive user's 200 invites. In some embodiments, application 130 may automatically connect two users based on user specifications and criteria. Settings regarding communications by user 200 may be modified to enable user 200 to prevent the system from automatically connecting user 200 to another user or letting another user follow the user 200, or letting another user message the user 200, as well as other settings.

In some embodiments special activities may be used which utilize one or more users 200 with one or more interactive apparatus system 100 controlled by a remote computing device 140 linked with the others by opt in or automatically, such as a theme park operator or concert operator whereby all the devices would link and display the same color or light patterns. As one example, one or more owners of interactive apparatus system 100 may meet at a designated location or be within a predetermined proximity of one another to create a collaboration whereby the displays are synced. In some embodiments, the system may determine if interactive apparatus system 100 are within proximity to one another whereby the location and time of both interactive apparatus system 100 may be compared for determining whether the interactive apparatus system 100 are at the same place at the same time. If the interactive apparatus system 100 are within a predetermined distance of one another at the same time then server 300 determines a positive correlation and creates a collaboration. The collaboration may be all interactive apparatus systems 100 showing a specific display or light sequence or a synchronized system where each interactive apparatus system 100 does something different to make up an ensemble.

The location may also be determined directly by a variety of sensing components such as optical cameras and infrared (IR) cameras, global positioning system, compass, wireless networks, or Bluetooth. The location component may then determine location information of the user based on the received information from the computing device 140. The cameras may also determine the location based on how far the body and face of users 200 are from the camera.

The interactive apparatus system may also incorporate proximity-based illumination responses for immersive experiences like treasure hunts organized by theme park or concert operators. In such scenarios, the system can be programmed to detect when users 200 approach designated objects of interest or hidden locations throughout the venue. When a user wearing or carrying interactive apparatus 100 comes within a predetermined proximity of these points of interest, the LED light assembly automatically transitions to a distinct color pattern or display sequence, providing visual feedback that signals discovery.

This proximity-triggered illumination can operate through various mechanisms including NFC tags, Bluetooth beacons, or GPS coordinates programmed into the application. Theme Park operators may design elaborate quests where participants follow a trail of color changes across their interactive apparatus, with each new illumination pattern providing clues about the next destination. Similarly, concert venues could implement scavenger hunts where specific light patterns indicate proximity to exclusive merchandise locations or special experiences, enhancing audience engagement beyond the main event while creating a community of participants with synchronized illumination patterns when objectives are successfully completed.

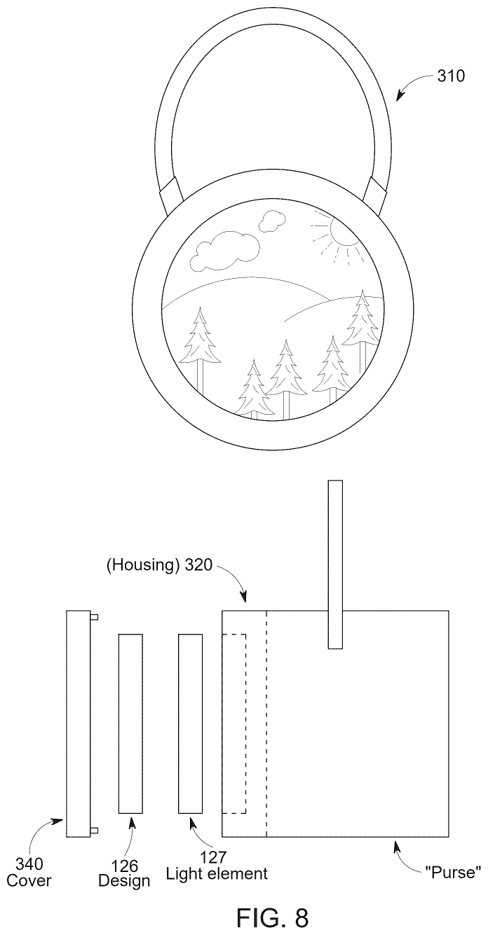

Another embodiment of interactive apparatus system 100 may be a purse 310 as illustrated in FIG. 8 with similar concept to headband 110 except 3D design elements 126 and LED light assembly 127 are directly attached to purse 310. Purse 310 may have a housing 320 whereby a cover 340 may be secured to the housing 320 to contain the components of the invention. Between cover 340 and housing 320 may be 3D design elements 126 and LED light assembly 127 positioned behind the 3D design elements 126. 3D design elements 126 and LED light assembly 127 may be positioned on any part of housing 320 such as the front, rear, sides, or bottom. Cover 340 may be removable such that user 200 may insert and remove one or more 3D design elements 126 for use.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. An interactive apparatus system comprising: first and second magnetic attachment plates fixedly secured to an apparatus; first and second modular components removably coupled to said first and second magnetic attachment plates respectively, each modular component comprising: a housing assembly comprising a hollow interior compartment and at least one three-dimensional design element disposed within said hollow interior compartment.

2. The interactive apparatus system of claim 1, further comprising a light assembly disposed within said hollow interior compartment.

3. The interactive apparatus system of claim 2, further comprising a control system comprising a wireless communication module; wherein said light assembly is configured to illuminate said three-dimensional design element; and wherein said control system is configured to receive wireless control signals from a remote computing device to adjust illumination parameters of said LED light assembly.

4. The interactive apparatus system of claim 3, wherein said illumination parameters comprise light color and intensity.

5. The interactive apparatus system of claim 1, further comprising a power system having a rechargeable battery pack disposed within at least one of said first and second modular components.

6. The interactive apparatus system of claim 1, wherein at least one of said first and second modular components further comprises a display screen.

7. The interactive apparatus system of claim 6, wherein said display screen is configured to display user-selectable visual content received wirelessly from a remote computing device.

8. The interactive apparatus system of claim 3, wherein said control system is further configured to synchronize the illumination parameters between said first and second modular components.

9. The interactive apparatus system of claim 3, wherein said control system is configured to communicate with an application executing on said remote computing device, said application providing a user interface for controlling said illumination parameters.

10. The interactive apparatus system of claim 1, wherein the apparatus is a headband having a flexible band portion configured to encircle a user's head.

11. The interactive apparatus system of claim 1, wherein the apparatus is a backpack.

12. A method of operating an interactive apparatus system comprising: receiving, at a control system of a modular component removably coupled to an apparatus, a wireless control signal from a remote computing device; adjusting, based on said wireless control signal, illumination parameters of a light assembly disposed within said modular component; illuminating, using the LED light assembly, a three-dimensional design element disposed within a hollow interior compartment of said modular component according to said adjusted illumination parameters.

13. The method of claim 12, further comprising: synchronizing said illumination parameters between first and second modular components.

14. The method of claim 12, further comprising: displaying visual content on a display screen integrated into said modular component, wherein said visual content is received wirelessly from said remote computing device.

15. An interactive apparatus system comprising: a housing, a light assembly, at least one three-dimensional design element; a control system comprising a wireless communication module configured to receive control signals from a remote computing device, wherein the light assembly is configured to illuminate said three-dimensional design element according to illumination parameters specified in said control signals.

16. The interactive apparatus system of claim 15, wherein the apparatus is a purse.

17. The interactive apparatus system of claim 15, wherein the apparatus comprises a cover to secure the light assembly and the three-dimensional design element to the housing.

18. The interactive apparatus system of claim 17, wherein the cover and the three-dimensional design element are removable.

19. The interactive apparatus system of claim 15, wherein said control system is configured to communicate with an application executing on said remote computing device, said application providing a user interface for controlling said illumination parameters.

20. The interactive apparatus system of claim 15, wherein said illumination parameters comprise light color and intensity adjustable through an application.
